(19) United States
(12) Patent Application Publication
(10) Pub. No.: US 2019/0317614 A1
(43) Pub. Date: Oct. 17, 2019

(54) VIRTUAL REALITY ACCESSORY

(71) Applicants: Jérome ARDOUIN, St Jean sur Mayenne (FR); Inria Institut National De Recherche En Informatique ET EN Automatique, Le Chesnay (FR)

(72) Inventors: Jérome ARDOUIN, St Jean sur Mayenne (FR); Anatole LECUYER, Rennes (FR)

(21) Appl. No.: 16/461,729

(22) PCT Filed: Nov. 17, 2017
(86) PCT No.: PCT/FR2017/053158

§ 371 Date: May 16, 2019

(30) Foreign Application Priority Data
Nov. 17, 2016 (FR) 1661148

(51) Int. Cl. G06F 3/0346; G06F 3/01; G08B 6/00

(52) U.S. Cl. CPC G06F 3/0346; G08B 6/00; G06F 3/012

(57) ABSTRACT

The invention relates to a virtual reality accessory comprising a headset (4), characterised in that it includes at least one control moment gyroscope (10) mounted on the headset (4) such as to even a torque in a particular direction on the headset (4), and a controller (12) which is connected to the control moment gyroscope (10) anti arranged to control same according to a control law in order to generate a haptic feedback linked to the movement of a user in a virtual reality simulation.

The invention relates to the field of virtual reality, and more particularly to the accessories suitable for virtual reality simulations.

Virtual reality is a field which is undergoing remarkable growth, and which is on the point of becoming a mass market. However, there are many challenges to be overcome, particularly with regard to the wellbeing of the users who use the virtual reality simulators.

In effect, when a user is immersed in a virtual reality simulation, it is commonplace for a conflict to develop between his or her sight, which perceives the movement in the simulation, and his or her vestibular system, which perceives a quasi-immobility. In the most favorable cases, this conflict is the cause of a lesser immersion of the user. In the worst cases, this conflict can make the user sick, this phenomenon being known as “simulator sickness”.

The invention improves the situation. To this end, it proposes a virtual reality accessory comprising a headset, characterized in that it comprises at least one gyroscopic actuator mounted on said headset so as to exert a torque with a respective direction on the headset, a controller linked to said gyroscopic actuator being arranged to control it according to a control law in order to produce a haptic feedback related to the movement of a user in a virtual reality simulation.

This accessory is particularly advantageous because it is portable and makes it possible to improve the immersion of the user without hampering his or her movement, without requiring anchorage in the physical environment of the place of the simulation.

According to miscellaneous variants, the accessory according to the invention can have one or more of the following features:
the accessory comprises four gyroscopic actuators mounted on said headset so as to each exert a torque with a respective direction on the headset, the controller being linked to each of said gyroscopic actuators and being arranged to control them together according to respective control laws in order to produce a haptic feedback related to the movement of a user in a virtual reality simulation,
the headset comprises an attachment portion for a virtual reality simulation device,
the headset receives a virtual reality simulation device,
the headset has the form of a mask,
the accessory comprises four gyroscopic actuators positioned substantially symmetrically in pairs relative to two axes of symmetry of the headset,
the gyroscopic actuators are each positioned at a corner of the mask,
the headset has a shell designed to be attached to the cranium of a user without covering the ocular region,
the accessory comprises four gyroscopic actuators positioned substantially symmetrically in pairs relative to two substantially orthogonal axes of symmetry of the headset, and
the gyroscopic actuators are positioned on the shell at a location corresponding substantially to a corner of a cranium.

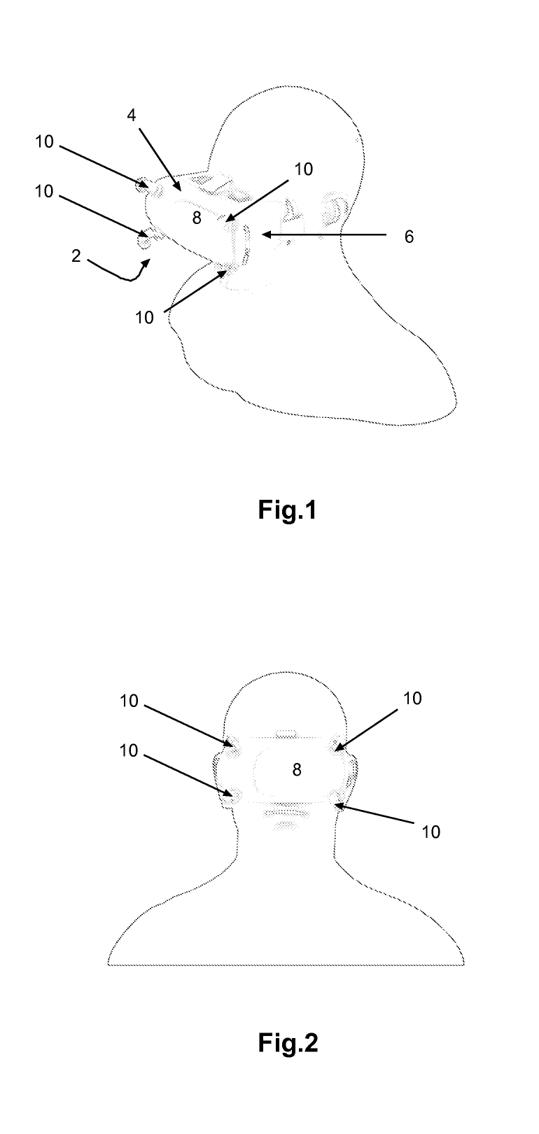

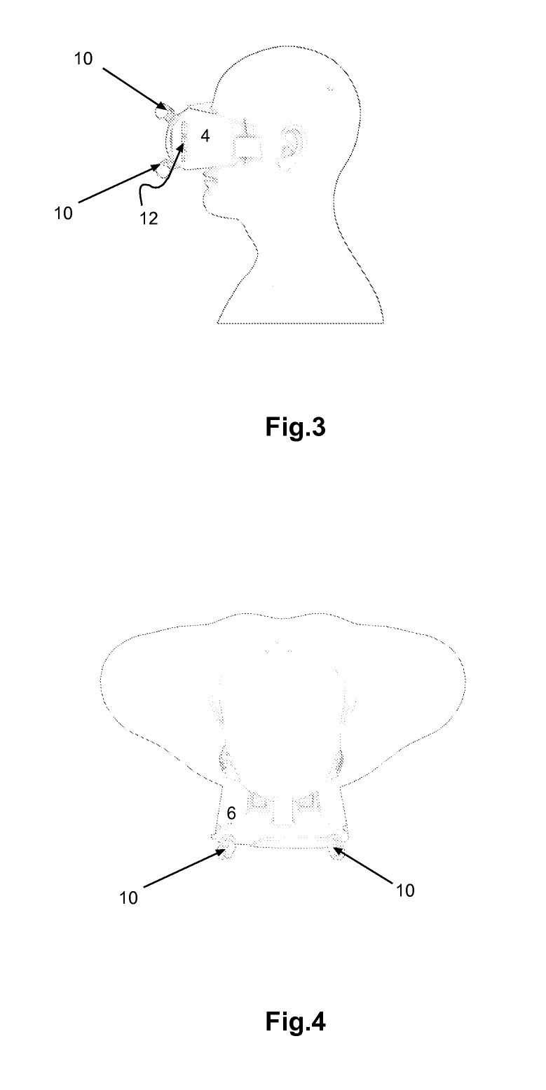

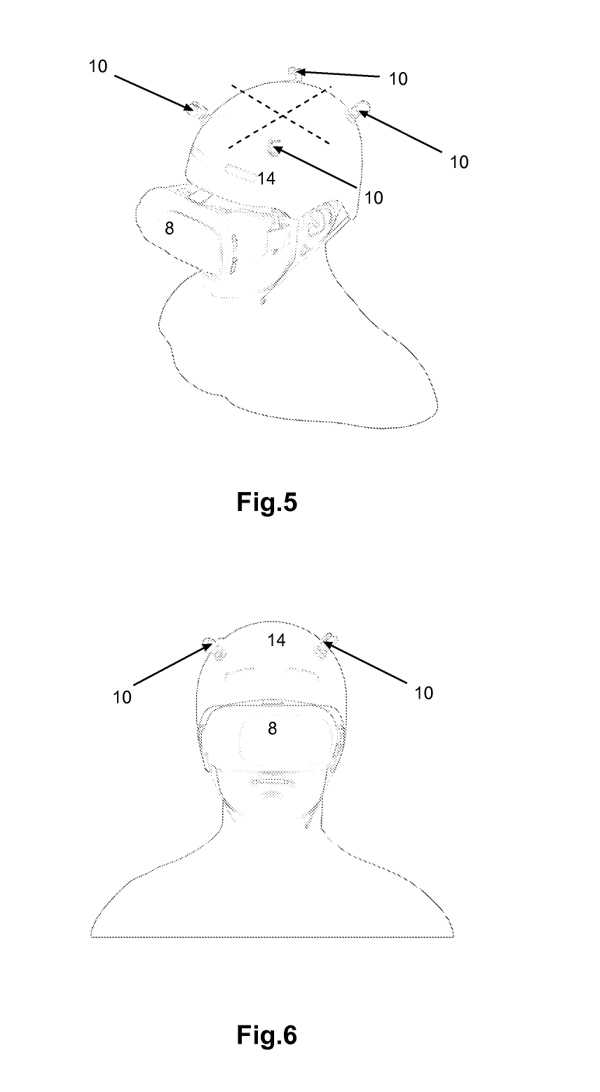

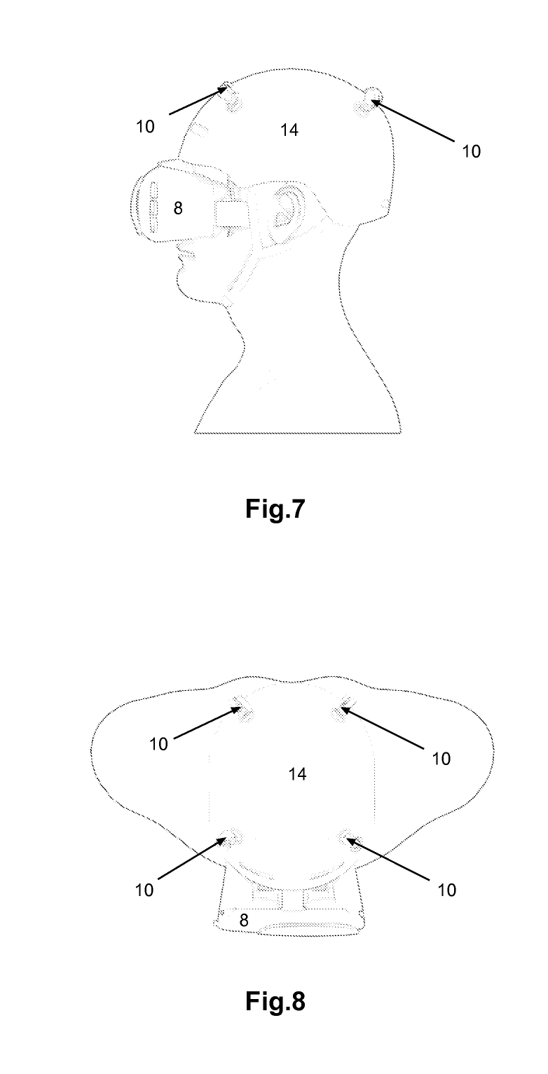

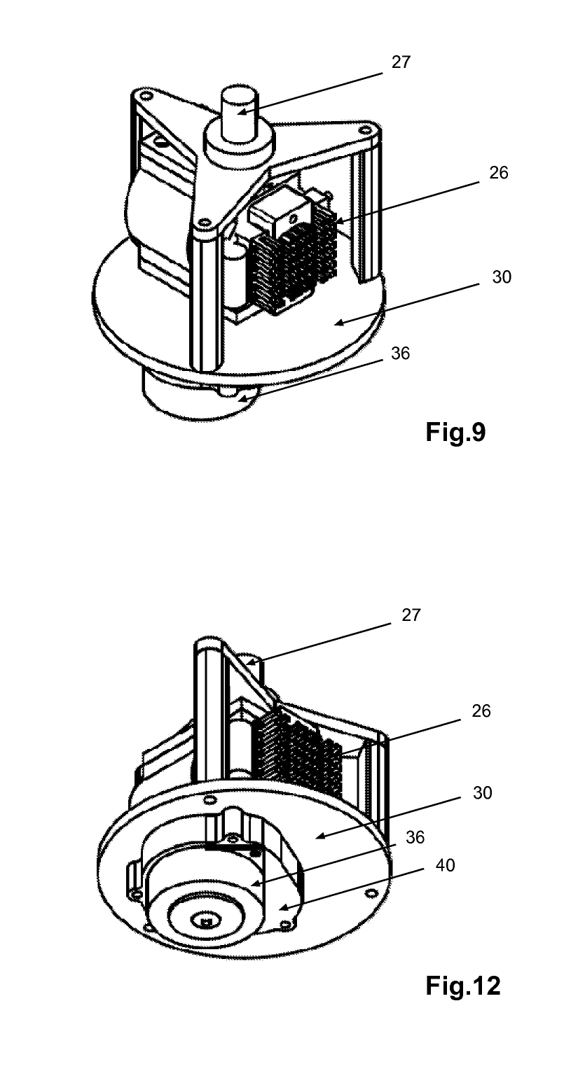

Other features and advantages of the invention will become more apparent on reading the following description, drawn from examples given in an illustrative and nonlimiting manner, taken from the drawings in which:
FIG. 1 represents a perspective view of a user wearing a virtual reality accessory according to a first embodiment of the invention,
FIGS. 2 to 4 respectively represent a front view, side view and top view of FIG. 1,
FIG. 5 represents a perspective view of a user wearing a virtual reality accessory according to a second embodiment of the invention,
FIGS. 6 to 8 respectively represent a front view, side view and top view of FIG. 5, and
FIGS. 9 to 11 represent miscellaneous views of a gyroscopic actuator that can be used in one of the accessories of FIGS. 1 to 8.

The drawings and the description hereinbelow contain, for the most part, elements of definite nature. There will therefore not only be able to be used to better understand the present invention, but also to contribute to the definition therefor, as appropriate.

FIG. 1 represents a perspective view of a user wearing a virtual reality accessory 2 according to a first embodiment of the invention. The following description of FIG. 1 is also made with reference to FIGS. 2 to 4.

The virtual reality accessory 2 comprises a headset 4 in the form of a mask, similar to the virtual reality headsets on the market like the Oculus Rift (registered trademark) or the HTC Vive (registered trademark), that is to say that it essentially covers the ocular region of the cranium of the user, without entirely covering the rest of the cranium.

In this embodiment, the headset 4 has an attachment portion 6 which receives a virtual reality simulation device 8. The attachment portion 6 allows for a direct exposure of the eyes of the user to the screen of the virtual reality simulation device 8, preferably so that the user perceives only the images of this screen, and no other light source. The virtual reality accessory 2 and the virtual reality simulation device 8 then form a head-mounted display. The virtual reality simulation device 8 will therefore be able to comprise one or more screens for displaying the simulation, and, optionally, simulation computation means.

As a variant, the headset 4 may not have any attachment portion, and the virtual reality simulation device 8 has its own attachment elements making it possible to place the latter on the cranium of the user at eye level.

The virtual reality accessory 2 also comprises four gyroscopic actuators 10. Each gyroscopic actuator comprises a flywheel, a motor driving the flywheel provided with control electronics for servo control at substantially constant speed, a precession motor of axis orthogonal to the drive motor provided with its control electronics allowing the assembly to be rotated, and a universal joint linking the drive motor to the precession motor.

In the example described here, the flywheel can be produced in the form of a weight of cylindrical or toroidal form, and the drive motor is capable of bringing the flywheel up to rotation speeds of the order of 2000 to 40 000 rpm.

The gyroscopic actuators 10 are, in the example described here, distributed at the four corners of the headset 4. Thus, each gyroscopic actuator 10 can be controlled according to a control law which is specific to it and which makes it possible to exert a torque on the headset 4 at the point at which it is positioned. For that, this law establishes how the precession motor must be actuated according to the desired torque and the precession angle of each actuator.

The virtual reality accessory 2 also comprises a controller 12 whose function is to control the gyroscopic actuators 10 together, according to their respective control law, in order to provide the user with a haptic feedback by means of the torques that they generate. In the example described here, the controller 12 is incorporated in the headset 4. The gyroscopic actuators 10 and the controller 12 are powered electrically by means of batteries that are not represented. Any type of battery will be able to be used, incorporated in the headset 4 or remote. The controller 12 will also be able to be remote from the headset 4. As a variant, the electrical power supply can be external, wired or wireless.

In the example described here, the controller 12 receives acceleration data from the virtual reality simulation device 8, and it converts these data into commands for each of the gyroscopic actuators 10. As a variant, the controller 12 can be simplified so that all the control computations of the actuators 10 are performed by the virtual reality simulation device 8 and the function of the controller 12 is the synchronized control of the gyroscopic actuators 10. The controller 12 can be linked to the virtual reality simulation device 8 by any appropriate means, whether wired, wireless, by a proprietary or a non-proprietary protocol, etc.

The applicant has discovered that the gyroscopic actuators offer many advantages for the application to the haptic feedback in the context of virtual reality simulations. In effect, they have the capacity to produce a torque of continuous and significant force, and, unlike the reaction wheels, they exhibit an available energy amplitude ratio that is worthwhile without any saturation effect.

Furthermore, the gyroscopic actuators make it possible to generate continuous torques, without interruption and without restriction in direction and do not require any external mechanical support, which makes the virtual reality accessory 2 particularly well suited to virtual reality simulations.

As an example, an acceleration rendered visually by the virtual reality simulation device 8 will be able to be reproduced by the virtual reality accessory 2 by means of a force applied by the headset 4 to the cranium of the user and proportional to this acceleration. As a variant, the force applied is not directly proportional to the acceleration, but is derived from the latter and/or from the speed.

In effect, in an acceleration in a car, the body is secured to the support (seat), and, in response to an acceleration of the vehicle, it accelerates, the cranium then undergoing a force of inertia, and in response, a torque having a tendency to rotate the cranium backwards. A similar phenomenon occurs in deceleration/braking or in turns.

The virtual reality accessory 2 therefore makes it possible to apply a force torque to the cranium in a way similar to what it undergoes when the user is seated in a vehicle.

Although the example described here uses four gyroscopic actuators in order to avoid any ambiguity in the feedbacks, three actuators will be sufficient to offer a haptic feedback from the movement in three dimensions to a user, even just one in order to simulate a roll or a pitch.

FIG. 5 represents a perspective view of a user wearing a virtual reality accessory 2 according to a second embodiment of the invention. The following description of FIG. 5 is also made with reference to FIGS. 6 to 8.

This second embodiment has a certain number of features in common with the first embodiment. So, only the differences will be described, numeric references that are identical denoting functionally similar features.

The main difference in this embodiment is that the virtual reality accessory 2 is designed to be mechanically distinct from the virtual reality simulation device 8. In this embodiment, there is no attachment portion 6. Thus, the headset 4 comprises a shell 14 which covers a significant part, even almost all, of the cranium of the user, apart from the ocular region.

That makes it possible to make the virtual reality accessory 2 compatible with more virtual reality simulation devices 8, and offers a greater freedom in the position of the gyroscopic actuators 10.

The virtual reality simulation device 8 is, in the example described here, a head-mounted display, which is placed over the face of the user without interfering with the headset 4.

In this embodiment, the gyroscopic actuators 10 are placed at four “corners” of the cranium, substantially symmetrically in pairs relative to two substantially orthogonal axes of symmetry of the headset 4. These axes are represented by dotted lines in FIG. 5. This placement of the gyroscopic actuators 10 allows for a finer control of the haptic feedback, as well as a firmer attachment of the headset 4 to the cranium of the user.

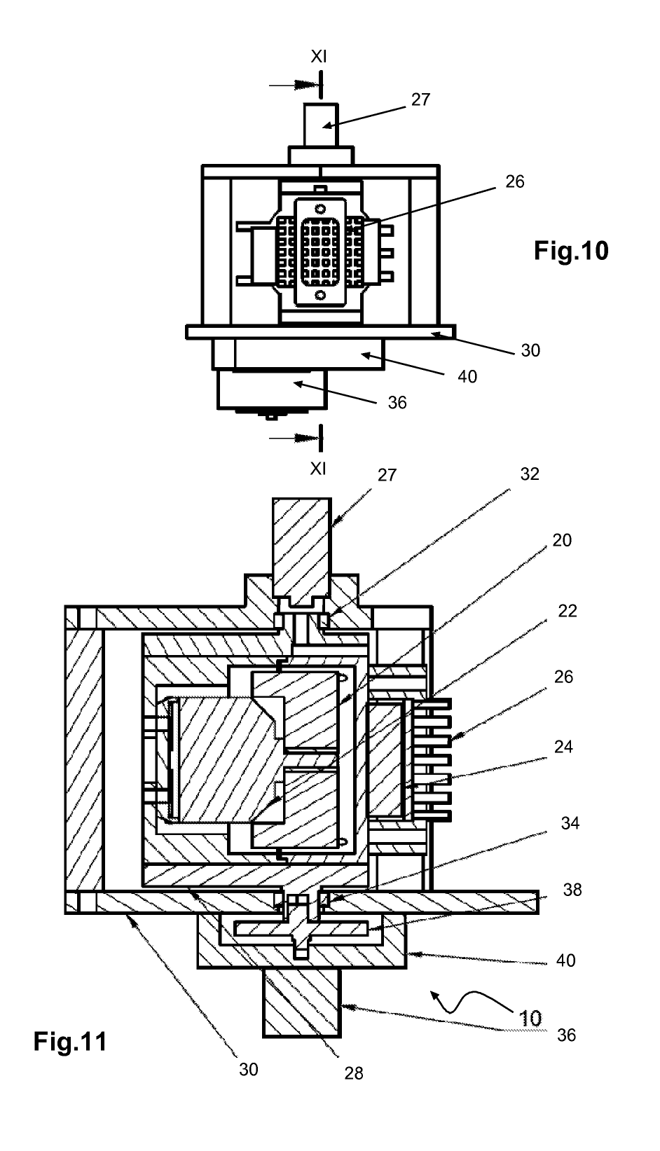

FIGS. 9 to 12 represent miscellaneous views of a particular gyroscopic actuator 10. FIG. 9 represents an isometric view of the gyroscopic actuator 10, FIG. 10 represents a side view according to the arrow X of FIG. 9, FIG. 11 represents a cross-sectional view along the axis XI-XI of FIG. 10, and FIG. 12 represents a view similar to that of FIG. 9 seen from below.

The gyroscopic actuator 10 comprises a rotor 20 acting as flywheel. The rotor 20 is driven by a brushless motor 22. The brushless motor 22 is controlled by a controller 24 implemented in the form of embedded electronics whose power components are thermally coupled with a radiator 26 acting as heat sink.

The electrical power and the control signals are routed to the controller 24 via a revolving commutator 27. The assembly of brushless motor 22, controller 24 and radiator 26 is mounted on a universal joint 28. The universal joint 28 is linked to a support 30 by rolling bearings 32 and 34 according to a pivot linkage.

The gyroscopic actuator also comprises a precession motor 36 of stepper type, and makes it possible to drive the universal joint 28 by means of a gear 38 secured to the axis of the universal joint 28. The gear mechanism 38 is protected by a casing 40 serving also as support for the precession motor 36.

In the above, reference has been made to virtual reality simulation devices. These devices can perform most of the computations necessary to the simulation or be primarily displays linked to separate computers. Furthermore, the concept of virtual reality within the meaning of the invention includes the simulations of a movement of a user, whether it be in a simulation, that is to say in a virtual world (for example a car or the like), or whether it be a remote control (for example the remote control of an operating robot). These virtual reality simulation devices can also include elements in addition to the display, provided to reproduce the simulated environment, such as touch-sensitive, auditory, visual elements.

1. A virtual reality accessory comprising a headset, characterized in that it comprises at least one gyroscopic actuator mounted on said headset so as to exert a torque with a respective direction on the headset, a controller linked to said gyroscopic actuator being arranged to control it according to a control law in order to produce a haptic feedback related to the movement of a user in a virtual reality simulation.

2. The accessory as claimed in claim 1, comprising four gyroscopic actuators mounted on said headset so as to each exert a torque with a respective direction on the headset, the controller being linked to each of said gyroscopic actuators and being arranged to control them together according to respective control laws in order to produce a haptic feedback related to the movement of a user in a virtual reality simulation.

3. The accessory as claimed in claim 1, wherein the headset comprises an attachment portion for a virtual reality simulation device.

4. The accessory as claimed in claim 3, wherein the headset receives a virtual reality simulation device.

5. The accessory as claimed in claim 1, wherein the headset has the form of a mask.

6. The accessory as claimed in claim 5, comprising four gyroscopic actuators positioned substantially symmetrically in pairs relative to two axes of symmetry of the headset.

7. The accessory as claimed in claim 6, wherein the gyroscopic actuators are each positioned at a corner of the mask.

8. The accessory as claimed in claim 1, characterized in that the headset has a shell designed to be attached to the cranium of a user without covering the ocular region.

9. The accessory as claimed in claim 8, comprising four gyroscopic actuators positioned substantially symmetrically in pairs relative to two substantially orthogonal axes of symmetry of the headset.

10. The accessory as claimed in claim 9, wherein the gyroscopic actuators are positioned on the shell at a location corresponding substantially to a corner of a cranium.
